(19) United States
(12) Patent Application Publication
(10) Pub. No.: US 2009/0059303 A1
(43) Pub. Date: Mar. 5, 2009

(54) IMAGE PROCESSING METHOD AND PRINTING APPARATUS

(75) Inventor: Shinichi Miyazaki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/196,508

(22) Filed: Aug. 22, 2008

(30) Foreign Application Priority Data
Sep. 3, 2007 (JP) 2007-228284

(51) Int. Cl. G06K 15/00

(52) U.S. Cl. 358/3.03

(57) ABSTRACT

N rasters of multi-valued data indicating a halftone image is input to a buffer and a pixel of interest to be quantized is quantized for the input multi-valued data. Furthermore, error of a quantized pixel is distributed to peripheral pre-quantization pixels including pre-quantization pixels in a raster of pixels quantized before the quantized pixel, and error distributed with respect to the pixel of interest is added to the multi-valued data for which quantization is yet to be processed. And the quantizing and distributing and adding of error are repeated while moving the pixel of interest in a column direction, and, when processing of N pixels has been completed in regard to the column direction, equivalent processing is repeated while moving the pixel of interest in a raster direction, thereby quantizing the multi-valued data of the N rasters.

### BACKGROUND OF THE INVENTION

1. Field of the Invention

The present invention relates to image processing methods and printing apparatuses that carry out halftone processing in which a multi-valued or binary pseudo halftone image is created from a digital halftone image.

2. Description of the Related Art

Conventionally, when printing a continuous tone image such as a photograph, printing is carried out such that the size of minute dots is varied, or printing is carried out by changing the density of minute dots. An error-diffusion method can be set forth as one typical halftoning method of a density preserving type in which a digital halftone image is converted to a binary pseudo halftone image.

With error-diffusion methods, tone is expressed by changing the density of minute dots. Error-diffusion methods are techniques of reducing error by diffusing error, which occurs when quantization has been carried out based on a comparison of an input tone vale and a threshold, with a predetermined ratio into adjacent pixels in a quantization processing direction (main scanning direction) and a direction orthogonal to the main scanning direction (sub-scanning direction). With error-diffusion methods, since the dots are arranged randomly and tone is expressed based on the density of the dots, these are methods in which both tonality and high resolution are achieved without it being necessary to consider occurrences of moiré.

Methods have been disclosed (for example, see Japanese Patent Laid-Open No. H03-151762) in which the quantization processing direction is arbitrarily switched for each predetermined raster as methods of carrying out error-diffusion processing with greater image quality. According to this method, by arbitrarily switching the quantization processing direction for each predetermined raster, it is possible to achieve that the direction of diffusion is no longer uniform. As a result, it is possible to suppress diagonal direction dot linkage, which appears in low density areas of printed images, and linkages of unprinted portion that appear in high density areas of printed images.

On the other hand, methods have been disclosed (for example, see Japanese Patent No. 3661624) as methods of carrying out error-diffusion processing with greater speed by carrying out determinations of whether or not to form a dot in parallel with regard to a plurality of rasters, thereby swiftly converting the image data of this plurality of rasters. According to this method, determinations of whether or not to form a dot are carried out in parallel with regard to a plurality of rasters, and therefore the frequency of access to a memory for reading and writing data is reduced, and therefore the determinations of whether or not to form dots can be carried out swiftly.

In recent years, image processing speeds have increased, outputable image sizes have become larger, dot sizes have become minute, and the sizes of image data that can be processed have become larger. Accompanying this, there is an issue in that even larger capacity memory sizes have become necessary for the input image data and error buffers and the like. On the other hand, despite having this issue, there is a calling for image quality of the printed image that is equivalent or higher than conventionally.

With the method described in the aforementioned Japanese Patent Laid-Open No. H03-151762, in order to obtain a printed image having high image quality, it is necessary to switch the quantization processing direction for each of a number of rasters that is as small as possible. Furthermore, it is necessary that error to be diffused to unprocessed pixels in the sub-scanning direction is held in a RAM as an error buffer at an amount corresponding to a number of pixels in the main scanning direction of the printed image. For this reason there is an issue in that a RAM is necessary having a large capacity memory size as the error buffer, and the processing times become undesirably longer since time is required for reading and writing to the memory for each raster.

On the other hand, in the method described in the aforementioned Japanese Patent No. 3661624, in order to carry out processing at high speed, it is necessary to carry out the determinations of whether or not to form dots in parallel with regard to a plurality of rasters. Between rasters to be processed in parallel, error can be held in a register that enables high speed reading and writing, thereby enabling high speed processing. However, it is difficult to switch the quantization processing direction for each raster since the determinations of whether or not to form dots are carried out in parallel. For this reason, in order to achieve an effect of suppressing dot linkage that appears in low density areas of printed images and linkages of unprinted portion that appear in high density areas of printed images, which is an effect of the method disclosed in Japanese Patent Laid-Open No. H03-151762, it is necessary to enlarge a range in which error that has occurred is to be diffused to peripheral unprocessed pixels. As a result, there is an issue in that the amount of computation for error to be diffused to unprocessed pixels undesirably increases.

### SUMMARY OF THE INVENTION

The present invention enables realization of an image processing method and a printing apparatus in which processing is carried out at high speed by reducing accessing to the memory during error-diffusion processing and in which halftone processing is carried out with excellent dispersion of dots. Furthermore, images are printed to a print medium based on a pseudo halftone image formed using the aforementioned image processing method.

According to a first aspect of the present invention, there is provided an image processing method for forming a pseudo halftone image by executing error-diffusion processing on a halftone image in which a position of each pixel is defined according to a raster direction and a column direction orthogonal to the raster direction, comprising: inputting to a buffer N rasters (N is an integer of 3 or higher) of multi-valued data indicating the halftone image, quantizing a pixel of interest to be quantized for the multi-valued data input to the buffer, distributing error of a pixel quantized by the quantizing to peripheral pre-quantization pixels including pre-quantization pixels in a raster of pixels quantized before the quantized pixel, adding error of the pixel of interest distributed by the distributing to multi-valued data for which quantization is yet to be processed, and performing control so that the quantizing, the distributing, and the adding are repeated while moving the pixel of interest in the column direction, and performing control so that, when processing of N pixels has been completed in regard to the column direction, the quantizing, the distributing, and the adding are repeated while moving the pixel of interest in the raster direction, thereby quantizing the multi-valued data of N rasters, wherein in the quantizing, involves carrying out quantization using 3 types of error-diffusion matrixes.

According to a second aspect of the present invention, there is provided a printing apparatus that prints an image on a print medium based on a pseudo halftone image formed using the above described image processing method.

Further features of the present invention will be apparent from the following description of exemplary embodiments with reference to the attached drawings.

### BRIEF DESCRIPTION OF THE DRAWINGS

FIG. 1 is a flowchart showing one example of ordinary error-diffusion processing.

FIG. 2 is a diagram showing one example of an error-diffusion matrix used in error-diffusion processing.

FIG. 3 is a flowchart showing error-diffusion processing according to embodiment 1.

FIG. 4 is a diagram showing an error-diffusion matrix used in error-diffusion processing according to embodiment 1.

FIGS. 5A and 5B are diagrams showing quantization processing direction and pixel processing order in error-diffusion processing.

FIG. 6 is a diagram showing one example of a result of error-diffusion processing.

FIG. 7 is a diagram for describing a cause of dots becoming linked in a chain-like manner.

FIG. 8 is a diagram illustrating one example of an error-diffusion matrix used in error-diffusion processing.

FIG. 9 is a diagram showing one example of a result of error-diffusion processing.

FIG. 10 is a diagram for describing a cause of dots concentrating in a specific raster.

FIG. 11 is a diagram illustrating a nozzle array of an inkjet printer according to embodiment 1.

FIG. 12 is a diagram illustrating a result of error-diffusion processing according to embodiment 1.

FIG. 13 is a flowchart showing error-diffusion processing according to embodiment 2.

FIG. 14 is a diagram showing an error-diffusion matrix used in error-diffusion processing according to embodiment 2.

FIG. 15 is a diagram showing quantization processing direction and pixel processing order in error-diffusion processing according to embodiment 2.

FIG. 16 is a perspective view of an external appearance of an inkjet printing apparatus according to the present embodiment.

FIG. 17 is a perspective view of an external appearance of an inkjet printing apparatus according to the present embodiment.

FIG. 18 is a block diagram showing a main control configuration of the printing apparatus shown in FIGS. 16 and 17.

### DESCRIPTION OF THE EMBODIMENTS

A preferred embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

In the present embodiment, an error-diffusion processing technique is given as an example of a density preserving type quantization method.

It should be noted that in this specification “print” indicates not only cases of forming meaningful information such as text and diagrams or the like, but also widely indicates cases of forming images, markings, and patterns or the like on a print medium, or carrying out processing on a medium, regardless of meaningfulness or meaninglessness. Furthermore, it is also irrelevant whether or not such cases involve actualization so as to be visible or perceivable by humans.

Furthermore, “print medium” indicates not only papers used in general printing apparatuses, but also widely indicates any material capable of receiving ink such as fabrics, plastic films, metal plates, glass, ceramics, wood, and leather.

Furthermore, “ink” is to be similarly widely interpreted as in the manner of the aforementioned definition of “printing,” and therefore indicates any liquid that can be supplied to formation of an image, marking, or pattern or the like by being applied to a print medium, or to the processing of a print medium, or to ink processing. Examples of ink processing that can be set forth include congealing or making insoluble a colorant in an ink that has been applied to a print medium.

Further still, unless indicated otherwise, a “nozzle” collectively refers to a discharge orifice and a liquid channel linked to this, and an element that produces energy used for discharging ink.

### Embodiment 1

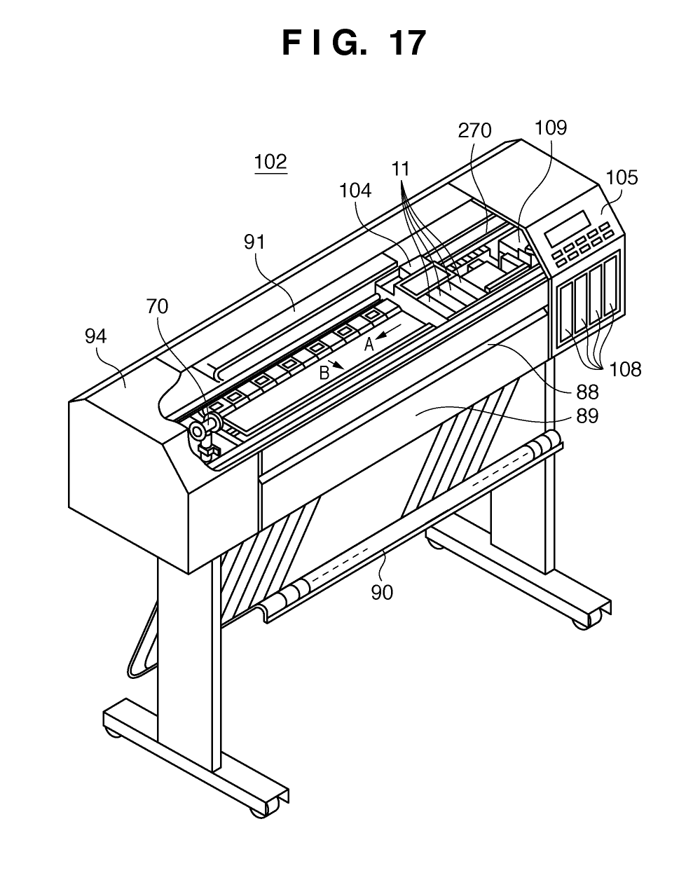

Outline description of inkjet printing apparatus main unit (FIGS. 16 and 17)

FIG. 16 is a perspective view of an external appearance of an inkjet printing apparatus according to the present embodiment, and FIG. 17 is a perspective view showing the inkjet printing apparatus shown in FIG. 16 with its upper cover removed.

As shown in FIGS. 16 and 17, a manual insertion opening 88 is provided at a front of the inkjet printing apparatus (hereinafter, printing apparatus) 102, and thereunder a roll paper cassette 89 is provided that is openable-closeable at the front face. A print medium such as printing paper (hereinafter, print medium) is supplied into the printing apparatus from the manual insertion opening 88 or the roll paper cassette 89. The inkjet printing apparatus is provided with an apparatus main unit 94 supported on two leg members 93, a stacker 90 into which discharged print media is stacked, and a transparent openable-closeable upper cover 91 through which the inside of the apparatus is visible. Furthermore, a control panel 12 and ink supply units 108 are arranged on a right side of the apparatus main unit 94. A control unit 105 is arranged behind the control panel 12.

The thus-configured printing apparatus 102 is capable of printing large images of a poster size such as A0 and B0.

As shown in FIG. 17, the printing apparatus 102 is provided with a conveying roller 70 for conveying the print medium in an arrow B direction (sub-scanning direction). Furthermore, a carriage unit (hereinafter, carriage) 104 is provided that is guided and supported so as to be capable of reciprocal movement in a width direction (an arrow A direction, main scanning direction) of the print medium. Driving force of a carriage motor (not shown) is conveyed to the carriage 104 via a carriage belt (hereinafter, belt) 270 so that the carriage 104 moves reciprocally in the arrow A direction. Inkjet printheads (hereinafter, printheads) 11 are mounted in the carriage 104. Ink discharge problems caused by blocking or the like of the discharge orifice of a printhead 11 are solved by a suction-type ink recovery unit 109.

In the case of this printing apparatus, the printheads 11, which are constituted by four heads corresponding to four color inks, are mounted in the carriage 104 in order to carry out color printing on the print medium. That is, the printheads 11 are constituted by a K head that discharges a K (black) ink, a C head that discharges a C (cyan) ink, an M head that discharges an M (magenta) ink, and a Y head that discharges a Y (yellow) ink. Due to this configuration, the ink supply units 108 include four ink tanks that contain K ink, C ink, M ink, and Y ink respectively.

When carrying out printing on the print medium based on the above configuration, first, the print medium is conveyed by the conveying roller 70 until a predetermined print commencement position. After this, printing is carried out on the entire print medium by repeating an operation of causing the printhead 11 to scan in the main scanning direction using the carriage 104 and an operation of causing the medium to be conveyed in the sub-scanning direction using the conveying roller 70.

That is, printing is carried out on the print medium by moving the carriage 104 in the arrow A direction shown in FIG. 17 using the belt 270 and the carriage motor. When the carriage 104 returns to its position (home position) prior to scanning, the print medium is conveyed in the sub-scanning direction by the conveying roller, after which the carriage again scans in the arrow A direction shown in FIG. 17, thereby carrying out printing of images and text or the like on the print medium. When the above-described operations are repeated and printing of one sheet portion of print medium is finished, the print medium is discharged into the stacker 90, and printing of one sheet portion of A0 size for example is completed.

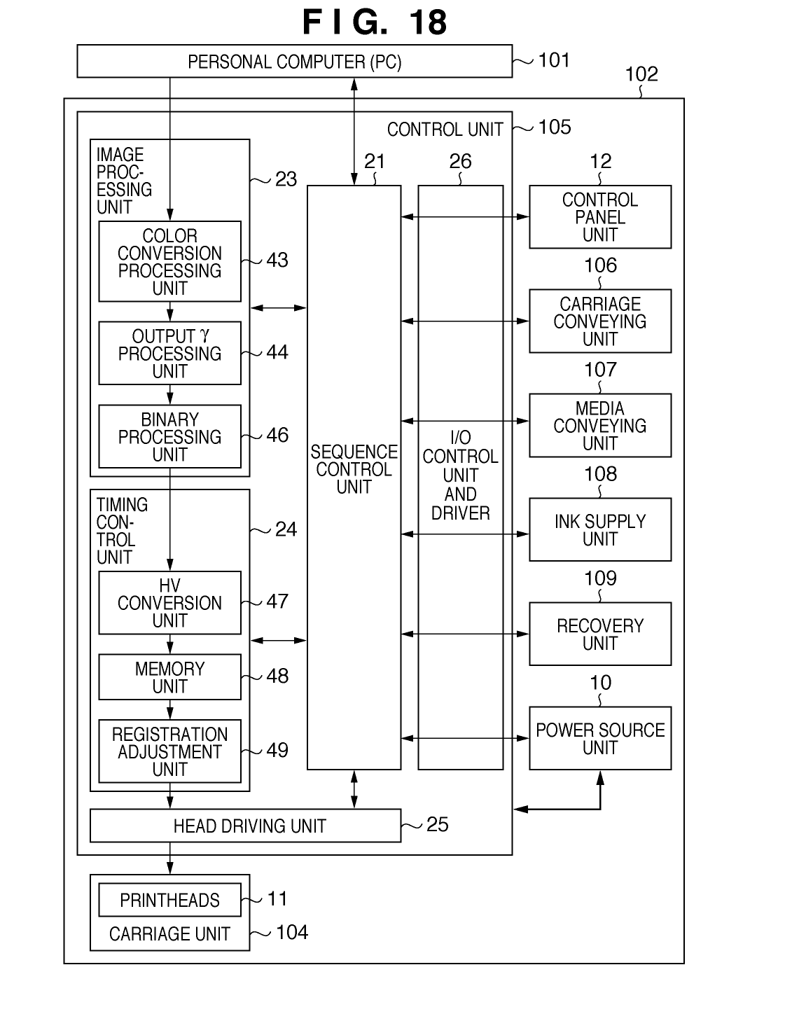

Description of control circuit of inkjet printing apparatus (FIG. 18)

FIG. 18 is a block diagram showing a main control configuration of the printing apparatus shown in FIGS. 16 and 17.

In FIG. 18, numeral 101 indicates a host device (a personal computer (PC) in this example) that supplies image data and commands, and the like. The printing apparatus 102 carries out reception of image data, commands, parameters, color processing LUTs (look up tables) and the like from the PC 101 and carries out printing of the received image data in accordance with the commands, parameters, and color processing LUTs.

The personal computer (PC) 101 is a general device having a keyboard and a display, and its interface with a user is achieved using application software, a dedicated printer driver for printing apparatus, and dedicated printer control software (a RIP or the like).

The printing apparatus 102 includes the control unit 105 that is provided with a CPU, ASIC, DMAC, RAM, ROM, or the like for controlling the printing apparatus 102 overall. Also included are the carriage 104 on which the printheads 11 are mounted and a carriage conveying unit 106 that reciprocally moves the carriage 104 in the main scanning direction. Additionally, the printing apparatus 102 includes a media conveying unit 107 that moves the print media in the sub-scanning direction, supply units 108 that supply ink to the printheads 11, and the recovery unit 109 that enables the printheads 11 to recover to a satisfactory state. Further still, the printing apparatus 102 is provided with a power source unit 10 that supplies a power source to the printheads 11 and a power source to the control unit 105 and other units, and the control panel 12, which has key switches and a display such an LCD or the like.

It should be noted that in this embodiment, although detailed diagrams and description of structural components are omitted, the printing apparatus 102 performs a serial printer operation.

The power source unit 10 is turned on and off by AC switches or software switches or the like on the control panel 12. Power sources of 3.3V and 5V voltages are supplied as logic power sources to the control unit 105, and a power source of 24V voltage is supplied to an actuator of each unit (motors or the like) via an I/O control unit and driver 26 inside the control unit. Furthermore, a head power source for the printheads 11 is supplied from the power source unit 10 at a set voltage value via a head power source control unit inside the control unit.

Functionally, the control unit 105 is provided with a sequence control unit 21 that manages overall operations, an image processing unit 23 that converts image data into print data, and a timing control unit 24 that performs timing regulation matching the print data to the operations of the printing apparatus 102. Also provided are units such as a head driving unit 25, which controls drive data, drive pulses, and drive voltages and the like of the printheads 11, and the I/O control unit and driver 26, which acts as an interface and carries out drive control among the sensors and actuators (motors and the like) for internal units of the printing apparatus 102.

Physically, the control unit 105 is a circuit board. In particular, the sequence control unit 21 is constituted by components such as a CPU, a ROM that stores programs for controlling the CPU and various types of data, a RAM that is used as a work area of the CPU and stores various types of data, and an I/F that controls an interface with the PC 101, which is the host device. On the other hand, the image processing unit 23, the timing control unit 24, and the head driving unit 25 are mainly constituted by memories such as ASICs and RAMs or the like, and the I/O control unit and driver 26 is constituted by electrical circuits such as general purpose LSI chips and transistors and the like.

The image processing unit 23 includes a color conversion processing unit 43, an output γ processing unit 44, and a binary processing unit 46 that carries out pseudo halftone processing, which is described in detail later. In the color conversion processing unit 43, luminance data (RGB color component data) from the PC 101 is converted to density data (K, C, M, and Y components) corresponding to ink colors based on an image processing LUT. The output γ processing unit 44 performs gamma conversion on the density data from the color conversion processing unit 43 based on output gamma characteristics of the printing apparatus 102. And the binary processing unit 46 converts the density data (multi-valued data) from the output γ processing unit 44 to binary image data by carrying out pseudo halftone processing using an error diffusion technique that is described later.

The timing control unit 24 includes an HV conversion unit 47, a memory unit 48, and a registration adjustment unit 49. In the HV conversion unit 47, an arrayed order (a raster direction (main scanning direction) order) of the binary image data corresponding to the ink colors processed by the image processing unit 23 is converted to an order of an arrayed direction of the nozzles of the printheads 11 (a column direction (sub-scanning direction) order). The image data that has been converted to this column direction order is stored in the memory unit 48. In the registration adjustment unit 49, readout timings from the memory unit 48 are controlled for each set of image data corresponding to the ink colors in response to the position and movement direction or the like of the printheads 11 to perform adjustments such that the printing of each of the ink colors is not displaced.

Next, description is given regarding an error-diffusion method applied in the binary processing unit 46 of the thus configured printing apparatus.

It should be noted, as is evident from the above configuration, that the image density data is constituted by K, C, M, and Y components, but since the processing is equivalent for each of these color components, description is given here regarding the processing of only one of the color components. Furthermore, each pixel of the color components is expressed in 8 bits, and this 8-bit per pixel density data is binarized using error-diffusion processing.

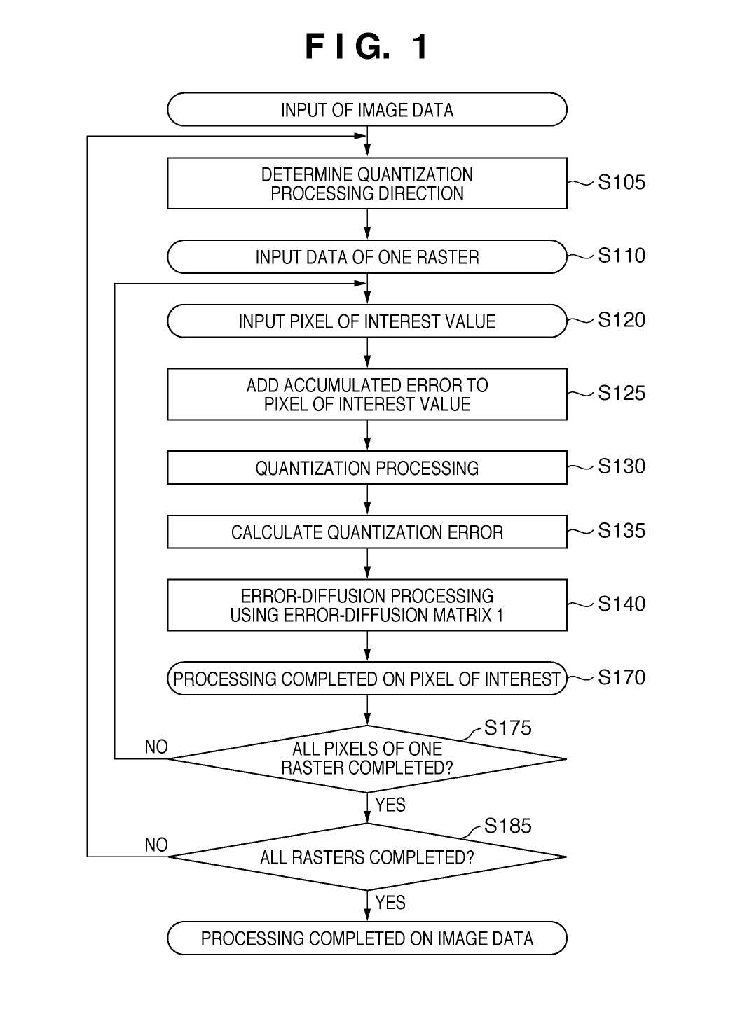

First, description is given using the flowchart in FIG. 1 regarding ordinary error-diffusion processing in which a binary pseudo halftone image is created from a halftone image having a processing bit number of 8 bits.

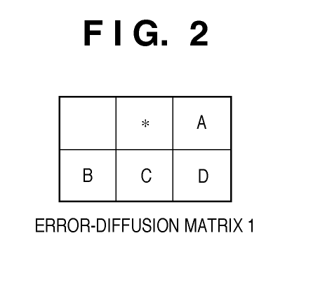

When image data is input, the image processing unit 23 determines a quantization processing direction (step S105). This determination is carried out before the error-diffusion processing commences for the raster data. The quantization processing direction is selected from two directions, these being from a left edge of an image to a right edge, or from the right edge to the left edge. The processing direction may be switched randomly using a random number of 0 or 1, or may be switched based on a predetermined regularity. Then, when data of one raster held in the buffer is input to the image processing unit 23 (step S110), the image processing unit 23 inputs a pixel of interest value In (step S120) for carrying out error-diffusion processing in the processing direction determined in step S105. Next, an accumulated error value Ecrt from peripheral pixels is added to the pixel of interest In (step S125). Then, an input correction value (In+Ecrt) and a threshold Th are compared in the binary processing unit 46 of the image processing unit 23 (step S130). Here, when the input correction value is greater than the threshold Th ((In+Ecrt)>Th), a dot is ON (output value 1), and when it is equal to or less than the threshold Th ((In+Ecrt)≦Th), the dot is OFF (output value 0). Then, in a case where the dot is ON, a quantization error Err that occurs for the pixel of interest to be quantized is calculated by Err=(In+Ecrt)−255, and in a case where the dot is OFF, it is calculated as Err=(In+Ecrt)−0 (step S135). When the quantization processing direction is from the left edge to the right edge of the image, the quantization error Err that has occurred at the pixel of interest is distributed to peripheral unprocessed pixels (step S140) using an error-diffusion matrix 1 shown in FIG. 2. It should be noted that the asterisk (*) in FIG. 2 indicates the pixel of interest and the error is distributed to pixels A to D shown in FIG. 2. When the quantization processing direction is from the right edge to the left edge of the image, an error-diffusion matrix is used that has a mirror-image relationship to the error-diffusion matrix 1. When processing is completed on the pixel of interest using the above-described process (step S175) and processing has been completed for all the pixels of the data of one raster input to the image processing unit 23, the image processing unit 23 transitions to a determining (step S185) of whether or not processing for all rasters have been completed. In a case where processing has not been completed for all the pixels of the one raster input to the image processing unit 23 in step S175, the procedure transitions to step S120 and processing is carried out on the next pixel of interest. When processing for all the rasters are completed in step S185, processing is completed for the image data, and when processing for all the rasters are not completed, a determination of the quantization processing direction (step S105) is carried out for the data of the next one raster.

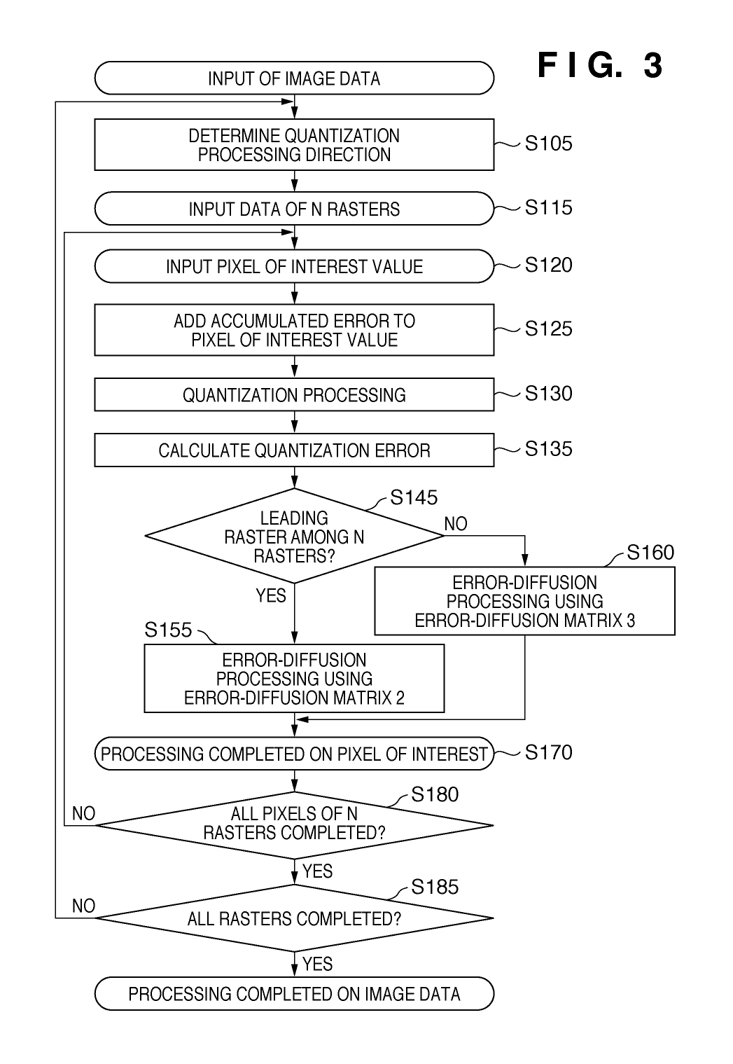

Next, description is given using the flowchart in FIG. 3 regarding error-diffusion processing according to the present embodiment in which a binary pseudo halftone image is created from a halftone image having a processing bit number of 8 bits. The error-diffusion processing according to the present embodiment is error-diffusion processing in which the quantization processing direction is switched for each N rasters (N is an integer of 2 or more), and error that occurs in (N−1) rasters excluding a leading raster is distributed in a range including unprocessed pixels of rasters before the raster being processed. It should be noted that the same numbers are used for processes that are the same in FIG. 1.

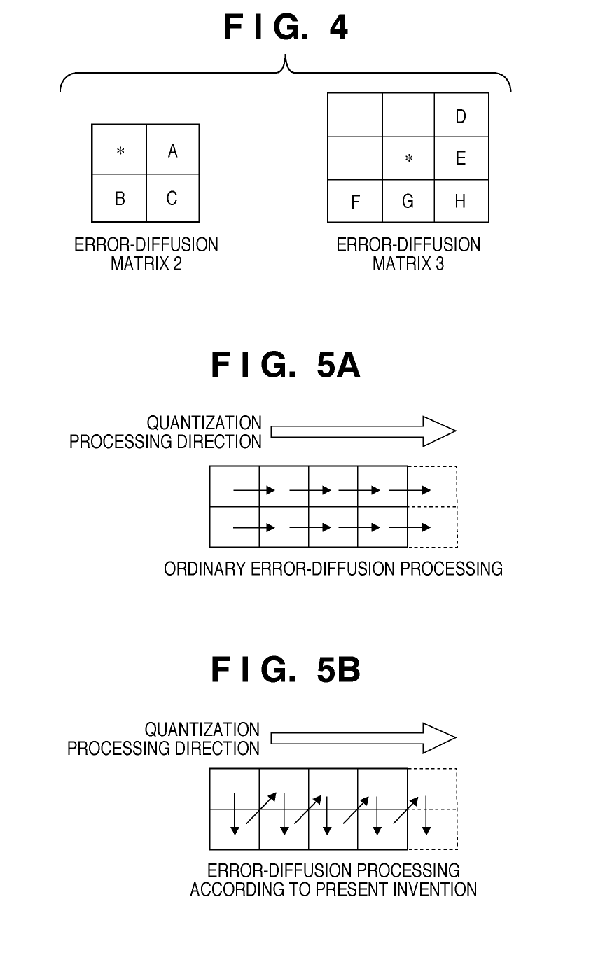

The process of step S105 is the same as the process of step S105 in FIG. 1 and therefore a description thereof is omitted, but in the present embodiment, the quantization processing direction is switched for each N rasters. Then, the data of the N rasters held in the buffer is input to the image processing unit 23 (step S115) and the procedure transitions to step S120. The processing from step S120 to step S135 is the same processing as from step S120 to step S135 in FIG. 1 and therefore description thereof is omitted. When the processing direction is from the left edge to the right edge of the image, the error that has occurred in step S135 is distributed to peripheral unprocessed pixels (step S155) using an error-diffusion matrix 2 shown in FIG. 4 if the pixel of interest is in the leading raster among the N rasters (step S145). In a case where the pixel of interest is not in the leading raster among the N rasters, the error is distributed (step S160) in a range including unprocessed pixels of rasters before the raster being processed using an error-diffusion matrix 3 shown in FIG. 4. When the quantization processing direction is from the right edge to the left edge of the image, an error-diffusion matrix is used that has a mirror-image relationship to the error-diffusion matrix 2 and the error-diffusion matrix 3. It should be noted that an asterisk in FIG. 4 indicates a pixel of interest and the error is distributed to pixels A to H shown in FIG. 4. When processing is completed on the pixel of interest using the above-described process (step S170) and processing has been completed for all the pixels of the N rasters input to the image processing unit 23 (step S180), the image processing unit 23 transitions to a determining (step S185) of whether or not processing for all the rasters have been completed. In a case where processing has not been completed for all the pixels of the N rasters input to the image processing unit 23, the procedure transitions to step S120 and the image processing unit 23 carries out processing on the next pixel of interest. The processing of step S185 is the same processing as step S185 in FIG. 1 and therefore description thereof is omitted.

Error-diffusion processing, in which the quantization processing direction is switched for each two rasters and error that has occurred in one raster excluding the leading raster is distributed in a range including unprocessed pixels of a raster before the raster being processed, is given as an example and described in detail below with reference to the aforementioned flowchart.

An example is given in regard to a case where there is input of data of two rasters (step S115) and error-diffusion processing is carried out with the quantization processing direction for the data being from the left edge to the right edge of the image (step S105).

With ordinary error-diffusion processing, processing is carried out as shown in FIG. 5A in the quantization processing direction indicated by the large arrow, with processing performed pixel by pixel in the order indicated by the small arrows. When processing for the first raster has been completed, processing transitions to the second raster, with processing performed pixel by pixel in the quantization processing direction. In this case, the error-diffusion matrix 1 shown in FIG. 2 is used for both the first raster and the second raster.

On the other hand, with the error-diffusion processing according to the present embodiment, the error of the second raster is processed as shown in FIG. 5B so that error can be distributed in a range including unprocessed pixels of a raster (the first raster) before the second raster (see FIG. 4). The pixels of the first raster and the second raster are processed alternately, and for the first raster the error is distributed using the error-diffusion matrix 2 shown in FIG. 4 and for the second raster the error is distributed using the error-diffusion matrix 3 shown in FIG. 4. To express this differently, multi-valued data of N rasters is quantized by repeating the quantization for N pixels in a raster direction while shifting the pixel of interest in the column direction, and distributing the error of quantized pixels to pre-quantization pixels in accordance with an error-diffusion matrix.

In the present embodiment, diffused error to be distributed to N rasters to be processed in the same direction is held in a register, and the diffused error to be distributed to next N rasters is stored in a RAM. A CPU is constituted by a computing unit that carries out processing and a register that temporarily hold data during processing, and therefore the data held in the register can be processed at a higher speed than data stored in the RAM.

In the image processing apparatus disclosed in the aforementioned Japanese Patent Laid-Open No. H03-151762, error to be diffused in a next raster for each raster is stored in a RAM, which is a buffer for error of one raster, and is read out from the RAM and added when the multi-valued information of the next raster is input to the image processing unit. The present embodiment is configured so that diffused error to be distributed to two rasters to be processed in the same direction is held in a register, and the error of one raster to be diffused in a leading raster of the next two rasters is stored in a RAM. For this reason, access to the RAM is decreased by half compared to conventionally and processing can be performed at high speed.

Furthermore, in the present embodiment, the error that has occurred in one raster excluding the leading raster is distributed in a range including unprocessed pixels of rasters before the raster being processed. Whether carrying out the processing of FIG. 5A or FIG. 5B, access to the RAM is decreased compared to conventionally as mentioned earlier and processing can be performed at high speed.

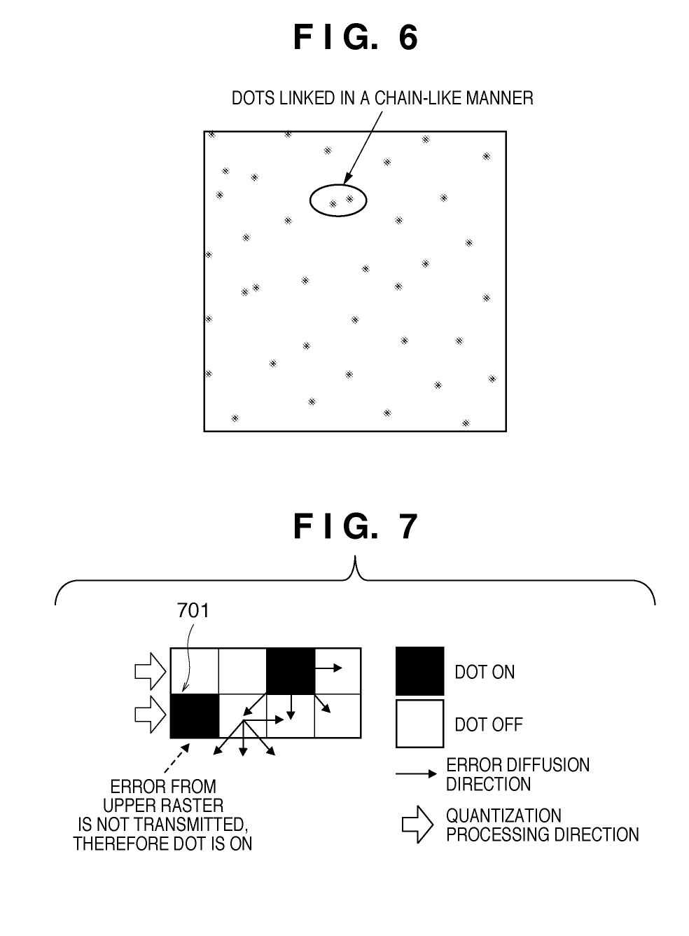

However, in a case of performing the processing of FIG. 5A, dots become linked in a chain-like manner as shown in FIG. 6 when processing is carried out using only the error-diffusion matrix 1 of FIG. 2, thereby reducing the dispersiveness of the dots. This seems to be because, as shown in FIG. 7, the range of diffusion for error is smaller and the direction of diffusion for error is the same direction, and therefore error from an upper raster is not transmitted to the pixel of numeral 701 in FIG. 7 and the pixel of numeral 701 in FIG. 7 becomes an ON dot, thereby reducing the dispersiveness of dots. Although this can be solved by enlarging the error-diffusion matrix (the range of diffusion for error), when the error-diffusion matrix is enlarged, unfortunately a proportionally longer processing time is required for calculating the error to be distributed.

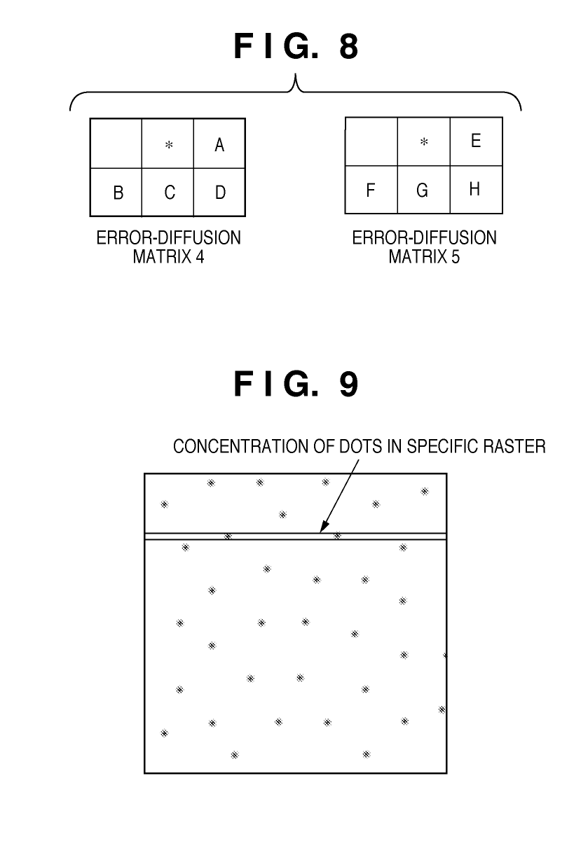

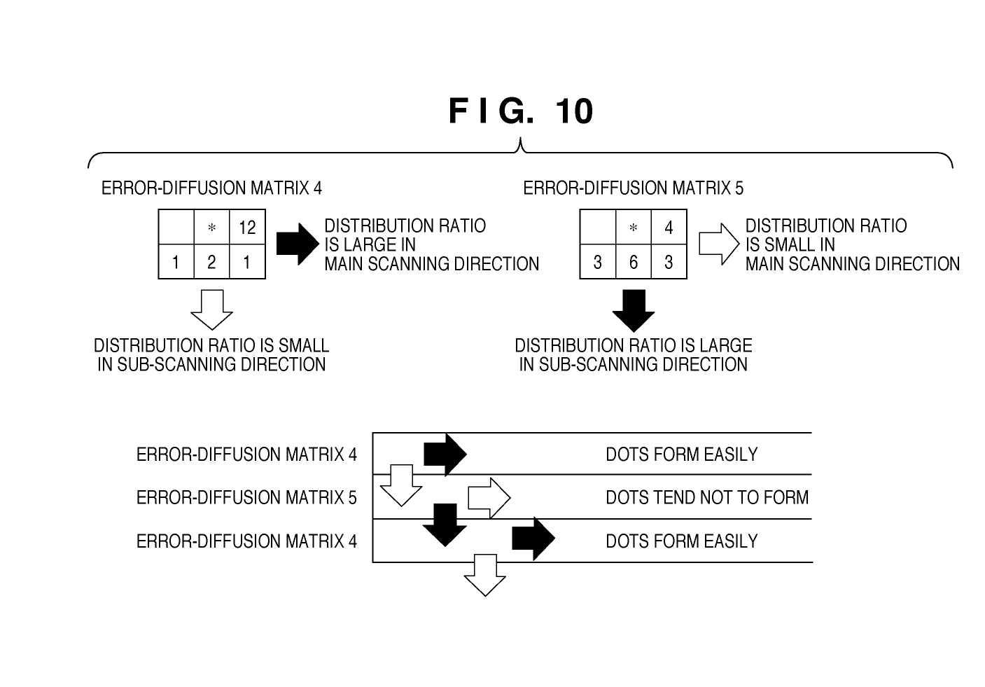

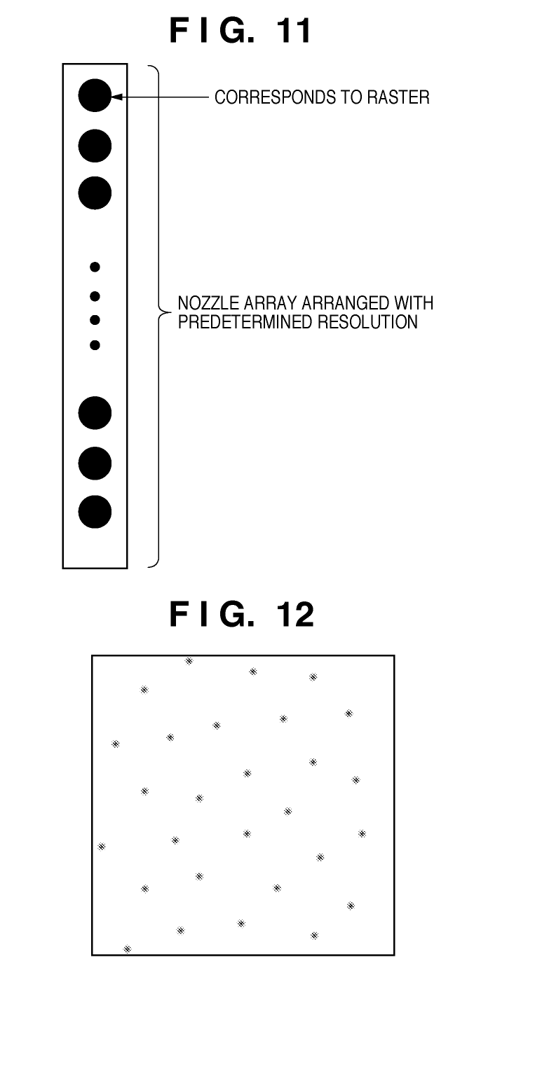

Furthermore, cases are conceivable of using error-diffusion matrixes having different error distribution ratios as shown in FIG. 8 with an error-diffusion matrix 4 for the first raster and an error-diffusion matrix 5 for the second raster. It should be noted that an asterisk in FIG. 8 indicates a pixel of interest and the error is distributed to pixels A to H shown in FIG. 8. Furthermore, it is indicated that the error distribution ratios are different between the error-diffusion matrix 4 and the error-diffusion matrix 5 by changing the symbols A to H between the error-diffusion matrix 4 and the error-diffusion matrix 5. In this case, when the error distribution ratios of the error-diffusion matrix 4 and the error-diffusion matrix 5 are set to similar values, the dots become linked in a chain-like manner as described earlier, thereby reducing the dispersiveness of the dots. On the other hand, when the error distribution ratio is increased in the main scanning direction for the error-diffusion matrix 4 and in the sub-scanning direction for the error-diffusion matrix 5, the dispersiveness of the dots is improved as shown in FIG. 9, but the dots concentrate in the raster in which the error distribution ratio has been set larger in the main scanning direction. This is because the error to be diffused concentrates in the raster in which the error distribution ratio has been set larger in the main scanning direction as shown in FIG. 10, and therefore a raster in which dots are formed easily and a raster in which dots tend not to form undesirably occur. Ordinarily, an image processing apparatus such as an inkjet printer that forms an image by discharging ink droplets has a nozzle array that is arranged with a predetermined resolution in a direction orthogonal to the raster direction as shown in FIG. 11. Each of the nozzles of this nozzle array corresponds to the rasters and ink is discharged from a predetermined nozzle to a predetermined print position. For this reason, when the dots concentrate in a specific raster as mentioned earlier, only the specific nozzles corresponding to that raster are used continuously in an undesirable manner, and therefore there are cases where the performance of those specific nozzles decreases faster than other nozzles.

For this reason, as in the present embodiment, the error that has occurred in one raster excluding the leading raster is distributed in a range including unprocessed pixels of rasters before the raster being processed. As a result, without enlarging the error-diffusion matrix, an output image can be obtained having excellent dot dispersiveness as shown in FIG. 12 without dots concentrating in a specific raster.

In this way, with the present embodiment, processing can be performed at high speed by reducing the accessing to the memory (RAM) compared to conventionally, and an output image can be obtained having excellent dot dispersiveness.

### Embodiment 2

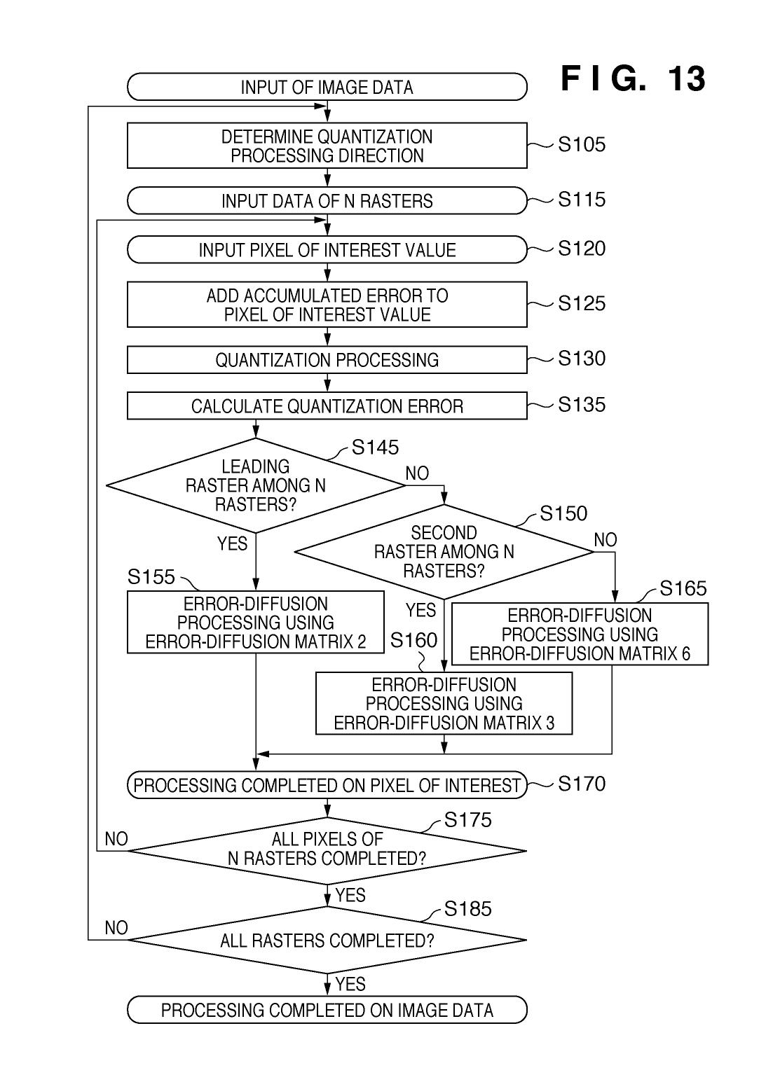

Processing according to the present embodiment is described using the flowchart in FIG. 13. It should be noted that same numbers are used for processes that are the same in FIG. 1 and FIG. 3 and that detailed description thereof is omitted.

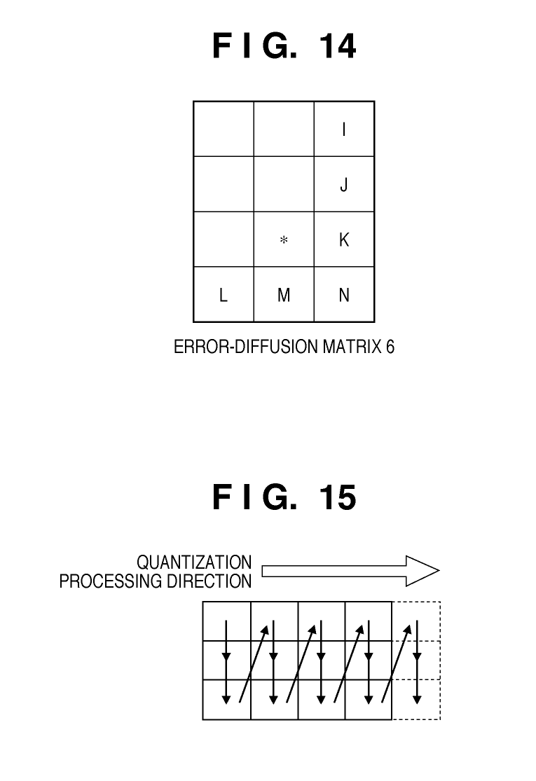

In the present embodiment, when the pixel of interest is not in the leading raster among the N rasters in step S145, the procedure transitions to step S150 and the image processing unit 23 determines whether or not the pixel of interest is in the second raster of the N rasters. Then, if it is in the second raster, error is distributed to peripheral unprocessed pixels using the error-diffusion matrix 3 (step S160), and if it is in any other raster, error is distributed using the error-diffusion matrix 6 shown in FIG. 14 (step S165). It should be noted that the asterisk in FIG. 14 indicates the pixel of interest and the error is distributed to pixels I to N shown in FIG. 14. Other than these processes, the processing is common to that of FIG. 3 of embodiment 1.

Error-diffusion processing, in which the quantization processing direction is switched for each three rasters and error that has occurred in two rasters excluding the leading raster is distributed in a range including unprocessed pixels of rasters before the raster being processed, is given as an example and described in detail below with reference to the aforementioned flowchart.

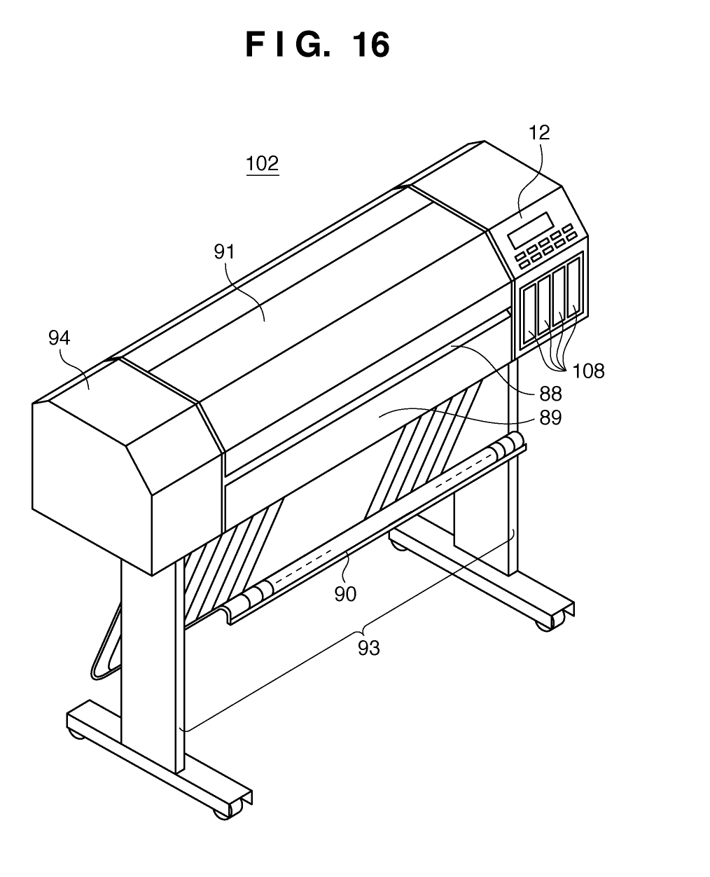

With the error-diffusion processing according to the present embodiment, the error of the second raster is distributed in a range including unprocessed pixels of a raster (the first raster) before the second raster. Furthermore, the error of the third raster is distributed in a range including unprocessed pixels of rasters (the first raster and second raster) before the third raster (see FIG. 14). Thus, processing is carried out as shown in FIG. 15. The pixels of the first raster, the second raster, and the third raster are processed in order, and for the first raster the error is distributed using the error-diffusion matrix 2, for the second raster the error is distributed using the error-diffusion matrix 3, and for the third raster the error is distributed using the error-diffusion matrix 6.

In the present embodiment, diffused error to be distributed to three rasters to be processed in the same direction is held in a register, and the diffused error to be distributed to next three rasters is stored in a RAM. For this reason, access to the RAM is decreased to one third compared to conventionally and processing can be performed at high speed. Further still, the error that occurs in the third raster is distributed throughout unprocessed pixels up to the first raster, and therefore an output image can be obtained having excellent dot dispersiveness even better than embodiment 1.

Above, description was given regarding two embodiments, but the present invention is not limited to these embodiments, and the present invention can be implemented in various other forms within a scope that does not depart from the gist thereof. For example, any value may be used for the bit number in the error-diffusion processing, and either the process of determining the quantization processing direction or the process of inputting data of N rasters may be first in order. Furthermore, error-diffusion matrixes were shown above as a mere example, and the diffusion range of the error-diffusion matrixes and the error distribution ratios are not limited to specific values. As long as it is an error-diffusion matrix in which diffusion of error is carried out in a range including unprocessed pixels of rasters before the raster being processed with regard to N rasters having quantization processing directions of the same direction, any error-diffusion matrix may be used. Further still, it is not necessary to use the error-diffusion matrix for all the rasters excluding the leading raster, and it may be used for at least a single raster among the rasters excluding the leading raster. Furthermore, any order may be used for the processing order of pixels in N rasters in which the quantization processing direction is the same direction, and can be varied in response to the error-diffusion matrix to be used. Furthermore, the processing direction for the quantization processing direction also may be determined randomly using a random number, or the processing direction may be determined based on a predetermined regularity.

Furthermore, in the above-described embodiments, N types of error-diffusion matrixes corresponding to N rasters in which the quantization processing direction is the same direction were used, but there is no limitation on the types of error-diffusion matrixes to be used.

Furthermore, in the above-described embodiments, multi-valued image data was input and this image data was converted to density image data on the printing apparatus side, and moreover the binarization processing (error-diffusion processing) was carried out in a dedicated circuit, but the present invention is not limited to this. For example, the binarization processing (error-diffusion processing) may be carried out on the host side such as a personal computer. In this case, the processing may be executed by software such as a printer driver or the like.

It should be noted that the present invention may be applied to a system constituted by a plurality of devices (for example, a host computer, an interface device, a reader, and a printer or the like).

Furthermore, an object of the present invention may also be accomplished by supplying a storage medium containing a program that achieves the functionality of the foregoing embodiments to a system or a device, and having a computer (or a CPU) thereof read out and execute the program. In this case, the actual program that is read out from the storage medium achieves the functionality of the above-described embodiments, and thereafter the program and the storage medium on which the program is stored constitute the present invention. Examples of storage media that can be used for providing the program include a floppy (registered trademark) disk, a hard disk, an optical disk, a magneto-optical disk, a CD-ROM, a CD-R, magnetic tape, a nonvolatile memory card, and a ROM or the like.

Furthermore, the present invention may also include having an OS (operating system) or the like that runs on a computer carry out a part of the actual processing according to instructions of the program read out by the computer such that the functionality of the foregoing embodiments is achieved by the processing thereof.

Further still, the present invention may also include writing the program read out from the storage medium to a memory provided in an extension board or an extension unit, then having a CPU or the like carry out a part or all of the processing according to instructions of the program, thereby achieving the functionality of the foregoing embodiments.

According to the above-described embodiments, the quantization processing direction is set to the same direction for each N rasters (N≧2), and error that occurs is distributed in a range including unprocessed pixels of rasters before the raster being processed. In this way, accessing to the memory is reduced during error-diffusion processing and excellent dispersion of dots can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-228284, filed Sep. 3, 2007, which is hereby incorporated by reference herein in its entirety.

What is claimed is:

1. An image processing method for forming a pseudo halftone image by executing error-diffusion processing on a halftone image in which a position of each pixel is defined according to a raster direction and a column direction orthogonal to the raster direction, comprising:
inputting to a buffer N rasters (N is an integer of 3 or higher) of multi-valued data indicating the halftone image,
quantizing a pixel of interest to be quantized for the multi-valued data input to the buffer,
distributing error of a pixel quantized by the quantizing to peripheral pre-quantization pixels including pre-quantization pixels in a raster of pixels quantized before the quantized pixel,
adding error of the pixel of interest distributed by the distributing to multi-valued data for which quantization is yet to be processed, and
performing control so that the quantizing, the distributing, and the adding are repeated while moving the pixel of interest in the column direction, and performing control so that, when processing of N pixels has been completed in regard to the column direction, the quantizing, the distributing, and the adding are repeated while moving the pixel of interest in the raster direction, thereby quantizing the multi-valued data of N rasters,
wherein in the quantizing, involves carrying out quantization using 3 types of error-diffusion matrixes.

2. The image processing method according to claim 1, wherein the quantizing involves carrying out quantization on the N pixels while moving the pixel of interest in order in the column direction.

3. The image processing method according to claim 1, wherein the N is 3.

4. A printing apparatus that prints an image on a print medium based on a pseudo halftone image formed using the image processing method according to claim 1.
